(19) United States
(12) Patent Application Publication
(10) Pub. No.: US 2018/0234849 A1
(43) Pub. Date: Aug. 16, 2018

(54) BIOMETRIC-BASED DISABLING OF MOBILE DEVICE FEATURE(S)

(71) Applicant: INTERNATIONAL BUSINESS MACHINES CORPORATION, Armonk, NY (US)

(72) Inventors: Muneeb ARSHAD, Poughkeepsie, NY (US); Megan CAPOBIANCO, Poughkeepsie, NY (US); Gregory ECOCK, White Plains, NY (US); Vijai KALATHUR, Wappingers Falls, NY (US); Christopher R. POTTER, Poughkeepsie, NY (US); Daniela REGIER, New Paltz, NY (US); William H. SCOTT, Fishkill, NY (US)

(21) Appl. No.: 15/433,120

(22) Filed: Feb. 15, 2017

(51) Int. Cl. H04W 12/08; H04W 12/06; H04L 29/06

(52) U.S. Cl. CPC H04W 12/08; H04L 63/0861; H04W 12/06

(57) ABSTRACT

Biometric-based disabling of a mobile device is provided. The method includes enabling one or more biometric sensor(s) on a mobile device, and allowing setting of the biometric sensor(s) to enable use of the mobile device for a user. The method also includes providing disabling of one or more features of the mobile device for other users, and based on the biometric sensor(s) sensing an other user using the mobile device, automatically disabling the feature(s) of the mobile device, while allowing selected content on the mobile device loaded by the user to continue to be displayed or played on the mobile device for the other user. Disabling the feature(s) of the mobile device may include automatically placing the mobile device in a locked state to block any mobile device notifications, and to prevent the other user from interacting with the mobile device.

### BACKGROUND

There currently exist a wide variety of portable computing devices (i.e., mobile devices), including wireless computing devices, such as mobile telephones, personal digital assistants (PDAs), tablets, laptop computers, wireless computers, etc., which are small, lightweight, and easily carried or shared by users. These mobile devices (including cellular telephones, internet protocol (IP) telephones, smartphone devices, etc.), can communicate audio and data packets over wireless networks. In addition, mobile devices typically possess software applications such as photograph and video applications, music players, email programs, games, etc.

The ability to personalize configuration or add further capabilities to a mobile device continues to be an area of interest and ongoing research for, for instance, establishing commercial advantage in the industry.

### SUMMARY

Shortcomings of the prior art are overcome and additional advantages are provided through the provision of a computer-implemented method which includes enabling one or more biometric sensors on a mobile device, and allowing setting of the biometric sensor(s) to enable use of the mobile device for a user. Further, the method includes providing disabling of one or more features of the mobile device for other users, and based on the biometric sensor(s) sensing an other user using the mobile device, automatically disabling the feature(s) of the mobile device, while allowing selected content on the mobile device loaded by the user to continue to be displayed or played on the mobile device for the other user.

In another aspect, a system is provided for automatically disabling one or more features of a mobile device. The system includes a memory, and a processing circuit communicatively coupled to the memory. The system performs a method, including enabling one or more biometric sensors on the mobile device, and allowing setting of the biometric sensor(s) to enable use of the mobile device for a user. Further, the method includes providing disabling of one or more features of the mobile device for other users, and based on the biometric sensor(s) sensing an other user using the mobile device, automatically disabling the feature(s) of the mobile device, while allowing selected content on the mobile device loaded by the user to continue to be displayed or played on the mobile device for the other user.

In a further aspect, a computer program product is provided for automatically disabling one or more features of a mobile device. The computer program product includes a computer readable storage medium readable by a processing circuit and storing instructions for execution by the processing circuit for performing a method, including enabling one or more biometric sensors on a mobile device, and allowing setting of the biometric sensor(s) to enable use of the mobile device for a user. Further, the method includes providing disabling of one or more features of the mobile device for other users, and based on the biometric sensor(s) sensing an other user using the mobile device, automatically disabling the feature(s) of the mobile device, while allowing selected content on the mobile device loaded by the user to continue to be displayed or played on the mobile device for the other user.

Additional features and advantages are realized through the techniques of the present invention. Other embodiments and aspects of the invention are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 is a block diagram of a data processing system which may incorporate or implement one or more aspects of the present invention;

FIG. 2 depicts one embodiment of a process for disabling one or more features on a mobile device for non-registered users, in accordance with one or more aspects of the present invention;

FIG. 3 is an illustration of one example of an automatic process of disabling one or more features on a mobile device for a non-registered user(s), and enabling the feature(s) for the registered user, in accordance with one or more aspects of the present invention;

FIG. 4 depicts another embodiment of a computing system which may implement or facilitate implementing disabling and enabling processing, in accordance with one or more aspects of the present invention;

FIG. 5 depicts one embodiment of a cloud computing environment which may facilitate implementing, or be used in association with, one or more aspects of the present invention; and

FIG. 6 depicts an example of extraction model layers, which may facilitate implementing disabling and enabling processing, in accordance with one or more aspects of the present invention.

### DETAILED DESCRIPTION

The description that follows includes exemplary devices, systems, methods, techniques and instruction sequences that embody techniques of the present invention. However, it should be understood that the described invention may be practiced, in one or more aspects, without the specified details. In other instances, note that known protocols, structures and techniques have not been shown in detail in order not to obscure the invention. Those of ordinary skill in the art will appreciate that the described techniques and mechanisms may be applied to various systems to facilitate providing an automatic mobile device disabling facility, in accordance with one or more aspects of the present invention.

When a mobile device owner passes a mobile device to another individual to, for instance, view a photograph, graph, watch a video on the device, listen to music, etc., the device owner may want to limit interactions the recipient can perform on the mobile device. One way to accomplish this would be to preconfigure specific applications or specific device content with restrictions. This approach, however, entails the owner of the device providing input to signify that one or more particular applications on the device are to be locked, and then locking the application(s) in response to user input to thus restrict the ability of the guest user from accessing the application. The only way to exit from the lock is for the user owner to provide credentials, such as a password to unlock the application.

As another approach, described herein is a facility to temporarily disable or place the mobile device in a locked state to, for instance, limit the non-owner's interaction capabilities with the mobile device, while still allowing selected content on the mobile device loaded by the mobile device owner to continue to be displayed or played on the mobile device for the other user.

More particularly, described herein is a mobile device facility which can seamlessly detect a change in physical possession or viewing of the device via biometrics, and automatically place the mobile device into a restricted or locked state when the mobile device is in use by other than the owner or registered user. The lock state may disable, for instance, pop-up content or other notifications, as well as user interactions with the device while the other user (i.e., a non-registered user) is, for instance, viewing selected content on the mobile device loaded by the owner (i.e., a registered user). This action prevents the non-registered user from being able to view or interact with the device content in ways not intended by the registered user of the device. Advantageously, the solution disclosed herein does not require user action to secure any applications or content on the mobile device, but rather, may be provided to seamlessly, automatically lock or unlock the mobile device itself depending on who is using the device.

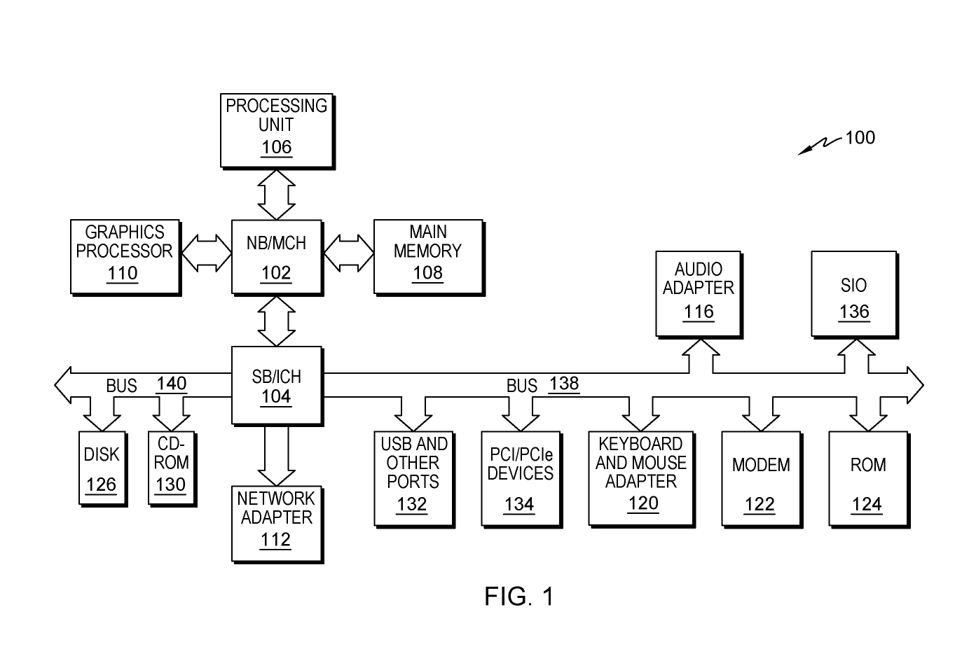

FIG. 1 depicts one embodiment, a block diagram of a data processing system 100 which may be used to implement one or more aspects of the present invention. For instance, data processing system 100 may be one example, at least in part, of a computer system associated with a user's mobile device, and may include computer usable program code or instructions implementing processes such as disclosed herein.

In the depicted example, data processing system 100 includes a hub architecture including a north bridge and memory controller hub (NB/MCH) 102 and a south bridge and input/output (I/O) controller hub (SB/ICH) 104. Processing unit 106, main memory 108, and graphics processor 110 are coupled to north bridge and memory controller hub 102. Processing unit 106 may contain one or more processors and even may be implemented using one or more heterogeneous processor systems. Graphics processor 110 may be coupled to the NB/MCH through an accelerated graphics port (AGP), for example.

In the depicted example, a local area network (LAN) adapter 112 is coupled to south bridge and I/O controller hub 104 and audio adapter 116, keyboard and mouse adapter 120, modem 122, read only memory (ROM) 124, universal serial bus (USB) and other ports 132, and PCI/PCIe devices 134 are coupled to south bridge and I/O controller hub 104 through bus 138, and hard disk drive (HDD) 126 and CD-ROM 130 are coupled to south bridge and I/O controller hub 104 through bus 140. PCI/PCIe devices may include, for example, Ethernet adapters, add-in cards, and PC cards for notebook computers. PCI uses a card bus controller, while PCIe does not. ROM 124 may be, for example, a flash binary input/output system (BIOS). Hard disk drive 126 and CD-ROM 130 may use, for example, an integrated drive electronics (IDE) or serial advanced technology attachment (SATA) interface. A super I/O (SIO) device 136 may be coupled to south bridge and I/O controller hub 104.

An operating system runs on processing unit 106 and coordinates and provides control of various components within data processing system 100 in FIG. 1. The operating system may be any commercially available operating system. By way of example, where the data processing system is implemented within a mobile device, a mobile operating system (OS) may be provided to allow applications and programs to run on the device. The mobile operating system also manages cellular and wireless network connectivity, as well as phone access. Examples of mobile device operating systems include Apple iOS, Google Android, Microsoft Windows Phone OS, as well as Microsoft's Windows 8, which functions as both a desktop operating system, and a mobile operating system.

Instructions for the operating system and applications or programs may be located on storage devices, such as hard disk drive 126, and may be loaded into main memory 108 for execution by processing unit 106. The processes of the illustrative aspects discussed herein may be performed by processing unit 106 using computer implemented instructions, which may be located in a memory such as, for example, main memory 108, read only memory 124, or in one or more peripheral devices.

The hardware embodiments depicted in FIG. 1 may vary depending on the desired implementation. Other internal hardware or peripheral devices, such as flash memory, equivalent non-volatile memory, or optical disk drives and the like, may be used in addition to or in place of certain hardware depicted in FIG. 1. Also, the processes of the illustrative aspects described herein may be applied to other hardware environments, such as to other mobile device implementations, as well as to other data processing systems

As noted, in one or more implementations, data processing system 100 may be configured as a mobile device, and be provided with flash memory to provide non-volatile memory for storing operating system files and/or user-generated data. A bus system may include one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 108 or a cache such as found in north bridge and memory controller hub 102. A processing unit may include one or more processors or CPUs. Those skilled in the art should note that the depicted system example of FIG. 1, as well as other examples referenced herein, are not meant to imply architectural limitations. Also, as briefly noted, data processing system 100 may be implemented as part of a mobile device such as a tablet computer, laptop computer, mobile telephone, personal digital assistant (PDA), wireless computer, etc.

As briefly noted, disclosed herein in one or more aspects, is a facility which temporarily places a mobile device in a disabled or locked state to, for instance, limit a non-owner's interaction capabilities with the mobile device. In one or more embodiments, the locking of, for instance, the screen to a current screen state running on the mobile device occurs automatically when the device is handed by a registered user to an other user (i.e., non-registered user). This action automatically results in (for example) disabling notifications, alerts, and any user input or interaction with the device. In one or more embodiments, the facility disclosed is a passive system (from the user viewpoint), which runs as a background process on the mobile device to recognize a change of user based on one or more biometric sensors. There are no profiles or gestures needed to accomplish this, and the locked state described herein is directed to the mobile device level. Further, the facility disclosed automatically operates quickly with, for example, a spontaneous handoff of a mobile device to, for instance, share a moment in time screen state, while protecting the privacy of the mobile device owner.

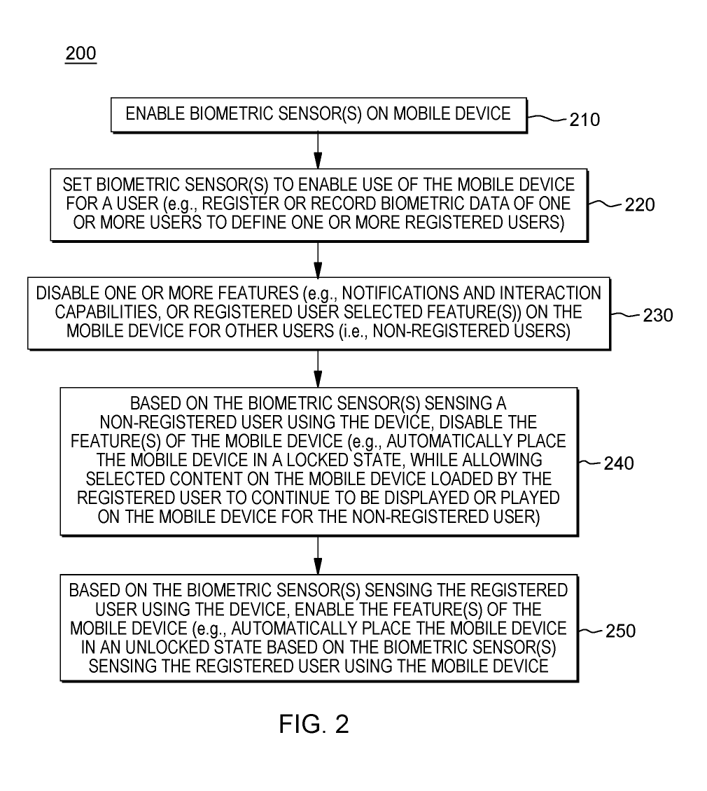

FIG. 2 depicts one embodiment of a process, generally denoted 200, for automatically disabling one or more features of a mobile device for a non-owner user of the mobile device. As illustrated, one or more biometric sensors on a mobile device are enabled 210 and the biometric sensor(s) are set to enable use of the mobile device for a user 220. For instance, the setting may include registering or recording biometric data of one or more owner users of the mobile device (referred to herein as the registered user(s)).

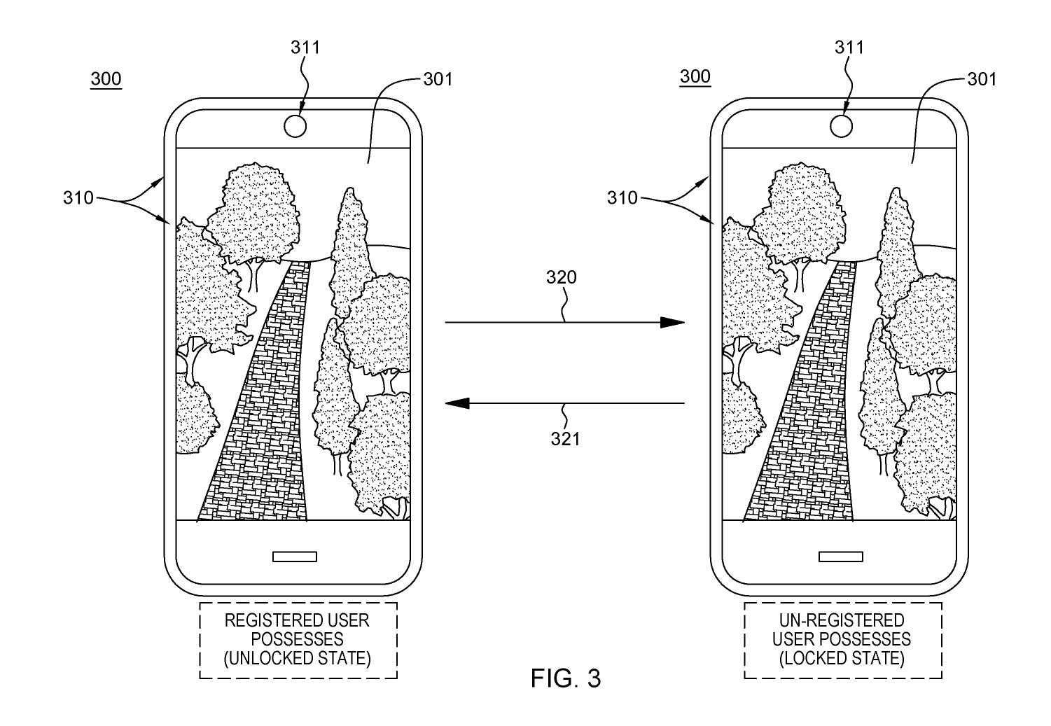

FIG. 3 illustrates one example of a mobile device 300 which includes multiple biometric sensors 310, 311, as well as a display screen 301. A variety of biometric sensors 310, 311 or devices may be employed in association with mobile device 300 in order to sense whether a registered user of the mobile device is using the device. Biometric authentication can include fingerprint authentication, facial recognition, iris print verification, etc. In one or more implementations, mobile device 300 may use multiple different types of biometric sensors 310, 311. For instance, biometric sensor 310 may be a fingerprint sensor and could be disposed on an edge or bezel of the device, with software being provided within the device (or remote, for instance, via a cloud-based service), which provides an ability to stitch together a full fingerprint from pieces of fingerprint images depending how a user is holding a device. Alternatively, biometric sensor 311 may comprise a camera or video monitor to facilitate via facial recognition detecting of a registered user, or conversely, detecting a non-registered user. Similarly, iris recognition could be used (via biometric sensor 311) to facilitate identification of a registered user, or conversely, use of the mobile device by a non-registered user. Note in this regard, that the setting of the biometric sensor(s) to enable use of the mobile device for one or more users, that is, one or more owner users of the mobile device, may include saving a facial image or iris scan, or fingerprint data on each owner user, thereby establishing the one or more owners as registered users, with any other user being automatically classified as a non-registered user should the biometric sensor data not match the recorded or registered data for the one or more registered users.

Continuing with the process of FIG. 2, one or more features of the mobile device itself are disabled, such as, for instance, pop-up notifications or alerts, as well as the ability of any non-registered user to interact with the mobile device 230. In one or more implementations, the facility described herein could also be provided with a user ability to select or customize specific features of the mobile device to be automatically disabled with possession of the device by a non-registered user, such as block pop-up notifications.

Based on the biometric sensor(s) sensing biometric data indicative of an other user using the device, then the feature(s) of the mobile device is disabled 240. For instance, the mobile device is automatically placed in a locked state. In this locked state, any selected content on the mobile device loaded by the user may continue to be displayed or played on the mobile device for the other user.

Based on the biometric sensor(s) sensing biometric data indicative of return of the mobile device to the registered user, that is, the registered user is now holding or using the device, the feature(s) of the mobile device may be enabled 250. For instance, the mobile device may be automatically placed in an unlocked state based on the biometric sensors sensing user biometric data which matches biometric data of the registered, owner-user.

In the example of FIG. 3, a registered user is using mobile device 300 and is identified via one or more of biometric sensors 310, 311, such that the mobile device is in an unlocked state. In this condition, the user has selected content on the mobile device to be loaded for display or play on the mobile device, for instance, within display 301. The registered user passes 320 the mobile device 300 to a non-registered user, who is immediately identified by the biometric sensor(s) 310, 311 data as being a non-registered user. In one or more implementations, this identifying may involve comparing the recipient's biometric data to stored biometric data of the one or more registered users of the mobile device. Based on the biometric sensors sensing biometric data indicative that the other user using the mobile device, the facility automatically disables one or more features on the mobile device, which may include disabling of mobile device notifications, as well as locking the mobile device to prevent the other user from interacting with the mobile device. Notwithstanding the disabling of these features, the selected content on the mobile device loaded by the registered user may continue to be displayed or played on the mobile device for the other user. At some time after possessing the mobile device 300, the non-registered user passes 321 the mobile device back to the registered user, at which time the biometric sensor(s) detects biometric data indicative of possession by the registered user, and automatically unlocks the mobile device.

Note that the facility disclosed herein seamlessly detects a change in physical possession of the mobile device via the sensed biometrics of the user. Responsive to this change, mobile device features, such as notifications, pop-up content on screen, and the ability to interact with the mobile device, such as to access applications, or other stored content, is automatically blocked. Advantageously, the facility does not require any repeated securing of mobile device applications or content, but rather, occurs automatically and seamlessly as a feature of the mobile device itself In one or more implementations, no user setup is required in order to implement the facility, while in one or more other implementations, the facility may provide the owner-user with the ability to select or limit the device features which are automatically disabled when the device is passed from a registered user to non-registered user. Further, note that the facility described herein would function also in any situation where a non-registered user picks up the mobile device. In such case, the mobile device automatically enters the locked state when the user's biometric data is identified as that of a non-registered user.

As a specific example, a user may register with the mobile device through one or more biometric identifiers, such as described herein. Content may be loaded on to the display of the mobile device that the registered user wishes to show an other individual. The registered user passes the mobile device to the other user, and the biometric sensor(s) on the mobile device automatically detects that the device is now being used by a non-registered user. Based on this, the one or more mobile device features are automatically disabled, such as any notifications, and the mobile device may be locked such that the non-registered user is unable to interact with the mobile device. This locked state continues until the mobile device reads biometric data of the registered user, based on which the device automatically unlocks.

Note also that the facility disclosed herein may be integrated with a mobile device's inactivity timer when, for instance, being held by a non-registered user. In this case, the mobile device may pause the inactivity timer so that the screen does not turn off while content is being displayed or played on the mobile device for the non-registered user. If the mobile device is not physically being held by user, and is not receiving biometric data, then the inactivity timer may proceed as normal, locking the mobile device according to the settings the user has specified once the time expires.

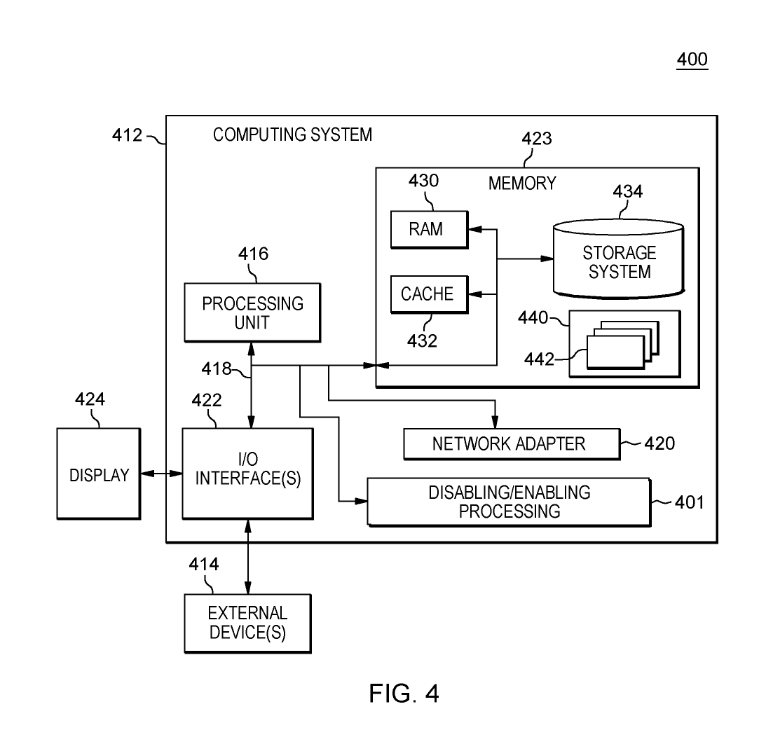

Further exemplary embodiments of a computing environment to implement one or more aspects of the present invention are described below with reference to FIGS. 4-6.

By way of further example, FIG. 4 depicts one embodiment of a computing environment 400, which includes a computing system 412. Examples of well-known computing systems, environments, and/or configurations that may be suitable for use with computer system 412 include, but are not limited to, a mobile device such as a wireless computer, a handheld or laptop computer or device, a mobile phone, a programmable consumer electronic device, a tablet, a personal digital assistant (PDA), and the like, as well as a server, a workstation, desktop computer, etc.

Computing system 412 may be described in the general context of computer system-executable instructions, such as program modules, being executed by a computer system. Generally, program modules may include routines, programs, objects, components, logic, data structures, and so on that perform particular tasks or implement particular abstract data types.

As depicted in FIG. 4, computing system 412, is shown in the form of a general-purpose computing device. The components of computing system 412 may include, but are not limited to, one or more processors or processing units 416, a system memory 423, and a bus 418 that couples various system components including system memory 423 to processor 416.

In one embodiment, processor 416 may be based on the z/Architecture® offered by International Business Machines Corporation, or other architectures offered by International Business Machines Corporation or other companies. z/Architecture® is a registered trademark of International Business Machines Corporation, Armonk, N.Y., USA. One embodiment of the z/Architecture® is described in “z/Architecture® Principles of Operation,” IBM Publication No. SA22-7832-10, March 2015, which is hereby incorporated herein by reference in its entirety.

In other examples, it may be based on other architectures, such as the Power Architecture offered by International Business Machines Corporation. One embodiment of the Power Architecture is described in “Power ISA™ Version 2.07B,” International Business Machines Corporation, Apr. 9, 2015, which is hereby incorporated herein by reference in its entirety. POWER ARCHITECTURE is a registered trademark of International Business Machines Corporation, Armonk, N.Y., USA. Other names used herein may be registered trademarks, trademarks, or product names of International Business Machines Corporation or other companies.

Bus 418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing system 412 may include a variety of computer system readable media. Such media may be any available media that is accessible by computing system 412, and it includes both volatile and non-volatile media, removable and non-removable media.

System memory 424 can include computer system readable media in the form of volatile memory, such as random access memory (RAM) 430 and/or cache memory 432. Computing system 412 may further include other removable/non-removable, volatile/non-volatile computer system storage media. By way of example only, storage system 434 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media could be provided. In such instances, each can be connected to bus 418 by one or more data media interfaces. As described below, memory 423 may include at least one program product having a set (e.g., at least one) of program modules that are configured to carry out the functions of embodiments of the invention.

Program/utility 440, having a set (at least one) of program modules 442, may be stored in memory 432 by way of example, and not limitation, as well as an operating system, one or more application programs, other program modules, and program data. Each of the operating system, one or more application programs, other program modules, and program data or some combination thereof, may include an implementation of a networking environment. Program modules 442 generally carry out the functions and/or methodologies of embodiments of the invention as described herein. Alternatively, a separate directions system, module, logic, etc., 401 may be provided within computing environment 412.

Computing system 412 may also communicate with one or more devices 414 such as a keyboard, a pointing device, a display 424, etc.; one or more devices that enable a user to interact with computing system 412; and/or any devices (e.g., network card, modem, etc.) that enable computing system 412 to communicate with one or more other computing devices. Such communication can occur via Input/Output (I/O) interfaces 422. Still yet, computing system 412 can communicate with one or more networks such as a local area network (LAN), a general wide area network (WAN), and/or a public network (e.g., the Internet) via network adapter 420. As depicted, network adapter 420 communicates with the other components of computing system, 412, via bus 418. It should be understood that although not shown, other hardware and/or software components could be used in conjunction with computing system 412. Examples, include, but are not limited to: microcode, device drivers, redundant processing units, external disk drive arrays, RAID systems, tape drives, and data archival storage systems, etc.

One or more aspects may relate to or use cloud computing.

It is understood in advance that although this disclosure includes a detailed description on cloud computing, implementation of certain teachings recited herein are not limited to a cloud computing environment. Rather, embodiments of the present invention are capable of being implemented in conjunction with any other type of computing environment now known or later developed.

Cloud computing is a model of service delivery for enabling convenient, on- demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

A cloud computing node may include a computer system/server, such as the one depicted in FIG. 4. Computer system/server 412 of FIG. 4 may be practiced in distributed cloud computing environments where tasks are performed by remote processing devices that are linked through a communications network. In a distributed cloud computing environment, program modules may be located in both local and remote computer system storage media including memory storage devices. Computer system/ server 412 is capable of being implemented and/or performing any of the functionality set forth hereinabove.

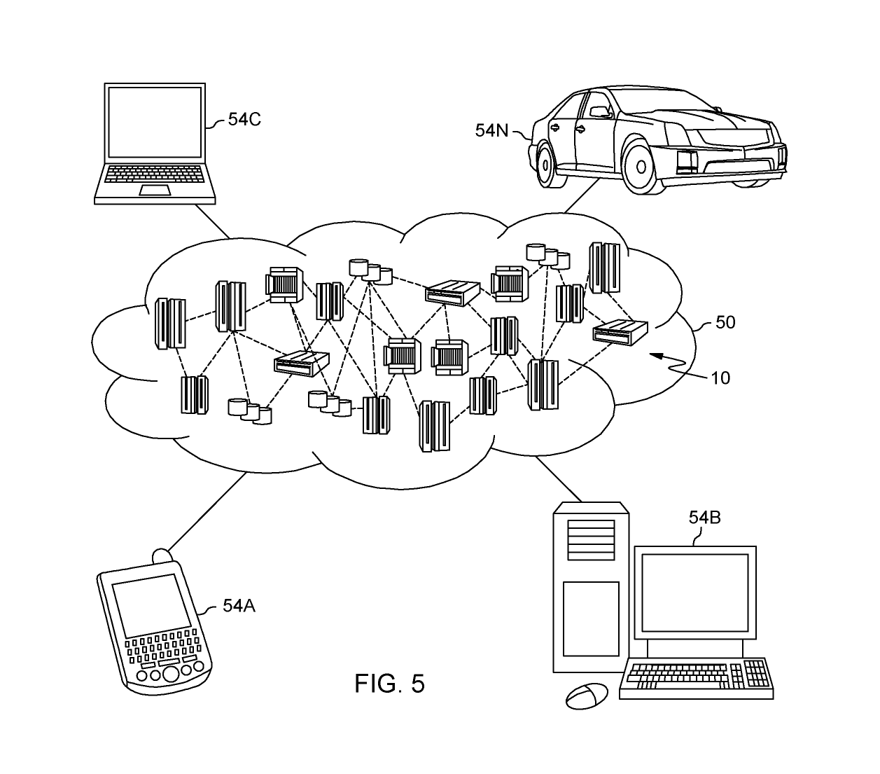

Referring now to FIG. 5, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

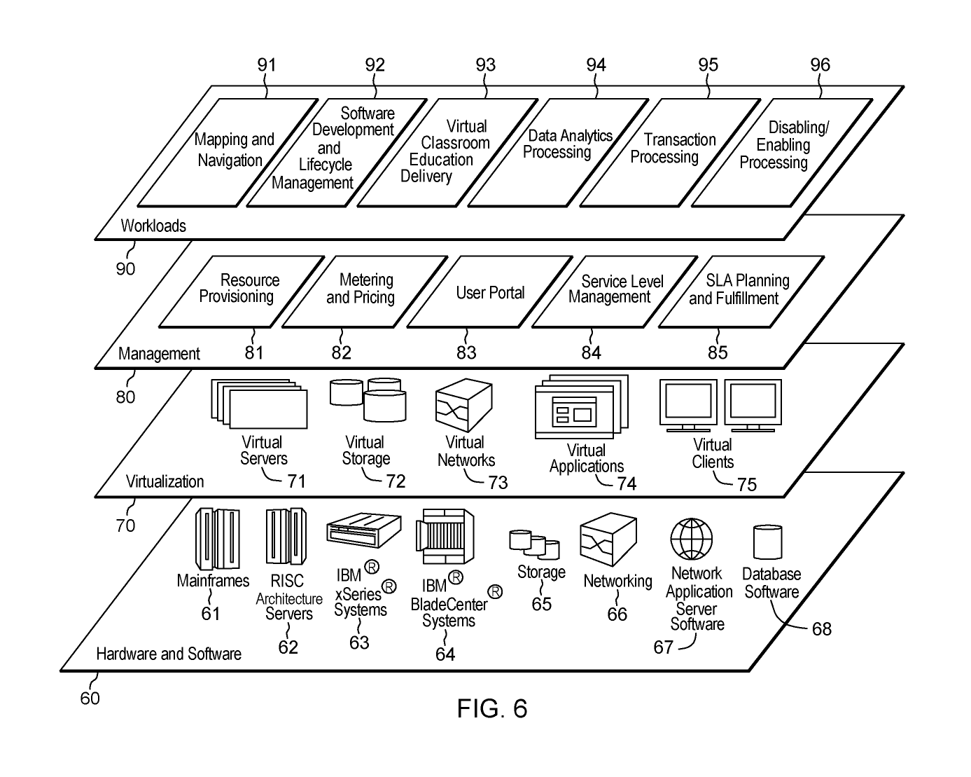

Referring to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and disabling and enabling processing 96.

The descriptions of the various embodiments of the present invention have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, computing environments of other architectures can be used to incorporate and use one or more embodiments. Further, different instructions, instruction formats, instruction fields and/or instruction values may be used. Many variations are possible.

Further, other types of computing environments can benefit and be used. As an example, a data processing system suitable for storing and/or executing program code is usable that includes at least two processors coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

1. A computer-implemented method comprising:
enabling one or more biometric sensors on a mobile device;
allowing setting of the biometric sensor(s) to enable use of the mobile device for an allowed user, the setting of the biometric sensor(s) to enable use of the mobile device for the allowed user automatically disabling, by the mobile device, features of the mobile device for other users without the allowed user being required to specify the automatic disabling or to lock the device while the allowed user's selected content is being displayed or played; and
based on the allowed user using the mobile device to display or play selected content, and based on the biometric sensor(s) subsequently sensing an other user using the mobile device while the selected content is being displayed or played, seamlessly disabling, by the mobile device, the features of the mobile device, while allowing the selected content to continue to be displayed or played on the mobile device for the other user.

2. (canceled)

3. The computer-implemented method of claim 1, wherein the automatically disabling the features of the mobile device comprises automatically placing the mobile device in a locked state, while allowing the selected content on the mobile device loaded by the allowed user to continue to be displayed or played on the mobile device for the other user.

4. The computer-implemented method of claim 3, further comprising automatically placing the mobile device in an unlocked state based on the biometric sensor(s) sensing the allowed user is using the mobile device.

5. The computer-implemented method of claim 3, wherein the biometric sensor(s) uses a plurality of biometric identifiers to determine whether the allowed user is using the mobile device.

6. (canceled)

7. The computer-implemented method of claim 1, wherein the setting of the biometric sensor(s) comprises setting the biometric sensor(s) to enable use of the mobile device for one or more allowed users, the allowed user being one allowed user of the one or more allowed users.

8. A system for automatically disabling one or more features of a mobile device, the system comprising:
a memory;
a processing circuit communicatively coupled with the memory, wherein the system performs a method comprising:
enabling one or more biometric sensors on a mobile device;
allowing setting of the biometric sensor(s) to enable use of the mobile device for an allowed user, the setting of the biometric sensor(s) to enable use of the mobile device for the allowed user automatically disabling, by the mobile device, features of the mobile device for other users without the allowed user being required to specify the automatic disabling or to lock the device while the allowed user's selected content is being displayed or played; and
based on the allowed user using the mobile device to display or play selected content, and based on the biometric sensor(s) subsequently sensing an other user using the mobile device while the selected content is being displayed or played, seamlessly disabling, by the mobile device, the features of the mobile device, while allowing the selected content to continue to be displayed or played on the mobile device for the other user.

9. (canceled)

10. The system of claim 9, wherein the automatically disabling the features of the mobile device comprises automatically placing the mobile device in a locked state, while allowing the selected content on the mobile device loaded by the allowed user to continue to be displayed or played on the mobile device for the other user.

11. The system of claim 10, further comprising automatically placing the mobile device in an unlocked state based on the biometric sensor(s) sensing the allowed user is using the mobile device.

12. The system of claim 10, wherein the biometric sensor(s) uses a plurality of biometric identifiers to determine whether the allowed user is using the mobile device.

13. (canceled)

14. The system of claim 8, wherein the setting of the biometric sensors comprises setting the biometric sensor(s) to enable use of the mobile device for one or more allowed users, the allowed user being one allowed user of the one or more allowed users.

15. A computer program product for automatically disabling one or more features of a mobile device, the computer program product comprising:
a computer readable storage medium readable by a processing circuit and storing instructions for execution by the processing circuit for performing a method comprising:
enabling one or more biometric sensors on a mobile device;
allowing setting of the biometric sensor(s) to enable use of the mobile device for an allowed user, the setting of the biometric sensor(s) to enable use of the mobile device for the allowed user automatically disabling, by the mobile device, features of the mobile device for other users without the allowed user being required to specify the automatic disabling or to lock the device while the allowed user's selected content is being displayed or played; and
based on the allowed user using the mobile device to display or play selected content, and based on the biometric sensor(s) subsequently sensing an other user using the mobile device while the selected content is being displayed or played, seamlessly disabling, by the mobile device, the features of the mobile device, while allowing the selected content to continue to be displayed or played on the mobile device for the other user.

16. The computer program product of claim 15, wherein the features are mobile device notifications.

17. The computer program product of claim 15, wherein the automatically disabling the features of the mobile device comprises automatically placing the mobile device in a locked state, while allowing the selected content on the mobile device loaded by the allowed user to continue to be displayed or played on the mobile device for the other user.

18. The computer program product of claim 17, further comprising automatically placing the mobile device in an unlocked state based on the biometric sensor(s) sensing the allowed user is using the mobile device.

19. The computer program product of claim 17, wherein the biometric sensor(s) uses a plurality of biometric identifiers to determine whether the allowed user is using the mobile device.

20-21. (canceled)

22. The computer-implemented method of claim 1, further comprising pausing an inactivity timer of the mobile device based on the biometric sensor(s) sensing the other user using the mobile device.
